(19) United States
(12) Patent Application Publication
(10) Pub. No.: US 2004/0158716 A1
(43) Pub. Date: Aug. 12, 2004

(54) Authentication and authorisation based secure ip connections for terminals

(76) Inventors: Esa Turtiainen, Espoo (FI); Jari Arkko, Kauniainen (FI); Pasi Ahonen, Oulu (FI)

Correspondence Address: JENKENS & GILCHRIST, PC, 1445 ROSS AVENUE, SUITE 3200, DALLAS, TX, 75202, US

(21) Appl. No.: 10/470,872

(22) PCT Filed: Jan. 17, 2002
(86) PCT No.: PCT/EP02/00509

(30) Foreign Application Priority Data
Feb. 8, 2001 (GB) 0103131.9

(51) Int. Cl. H04L 9/00

(52) U.S. Cl. 713/172

(57) ABSTRACT

A method of facilitating the authentication of IP data transfer between a mobile wireless terminal 4 and a network node 2. A computer is used to generate a public-private key pair, whilst a certificate guaranteeing that the key pair is associated with a unique identifier allocated to a subscriber is obtained from a CA 8. The key pair and the certificate are stored on a subscriber identity module (SIM) card 9 which is then coupled to the mobile wireless terminal 4 so that processing means of the terminal 4 can access the key pair and the certificate for use in authenticating itself to a remote node 2. The terminal is authorised to access services of the node 2 on the basis of the unique identifier.

The present invention relates to the security of IP data transfer and in particular to facilitating the authentication of IP data transferred between a mobile wireless terminal and a network node.

### BACKGROUND TO THE INVENTION

IP connections between mobile wireless terminals (such as mobile telephones and communicators) and entities such as Internet servers and corporate intranets are becoming increasingly popular. An organisation maintaining such a server or an intranet may wish to restrict access to selected users, and to ensure that all data transfer between the server/intranet and those users is secure. A necessary feature of a secure “Virtual Private Network” (VPN) is that the gateway to the server/intranet has some means of authenticating users (and vice versa).

IPSec (Internet Protocol Security) is a set of protocols defined by the Internet Engineering Taskforce (RFC2401) which provides a security mechanism for IP and certain upper layer protocols such as UDP and TCP. IPSec protects IP packets and upper layer protocols during transmission between peer nodes by introducing proof of origin and encryption.

In order to allow IPSec packets to be properly encapsulated and decapsulated it is necessary to associate security services (and parameters) between the traffic being transmitted and the remote node which is the intended recipient of the traffic. The construct used for this purpose is a “Security Association” (SA). SAs are negotiated between peer nodes using a mechanism known as “Internet Key Exchange” (IKE), and are allocated an identification known as a “Security Parameter Index” (SPI). The appropriate SA is identified to the receiving node by including the corresponding SPI in the IPSec header. Details of the existing SAs and the respective SPIs are maintained in a Security Association Database (SAD) which is associated with each IPSec node.

The security of the process depends crucially on the security of the initial identification of the nodes involved. A corporate intranet gateway needs to be sure that a mobile terminal initiating IKE is authorised to do so. IKE includes within it a mechanism to perform such authentication, as do other known mechanisms such as SSL and TLS. All of these mechanisms are based on public key cryptography and rely on the guarantee of a trusted (often independent) Certification Authority (CA) that a particular user is associated with a particular key. Each node must obtain a public-private key pair. Messages encoded with a node's private key can only be decoded with the corresponding public key, and those encoded with the public key can only be decoded with the private key. Thus if a node sends a message encoded with the private key, the recipient can authenticate the message as coming from that node if he can decode the message using the public key and if he can be sure that the public key is associated with that node. The CA's task is to ensure that the association between public keys and nodes can be trusted.

This is achieved by the CA issuing certificates to the nodes at the same time as they obtain their initial public-private key pair. The certificate for a particular node may include the public key of that node together with the identity of the node. The certificate is “signed” with a signature of the CA and which may be generated for example by encrypting, using a private key of the CA, data extracted from the node's public key and identity. Thus another node receiving this certificate can be sure it was “signed” by the CA if it can be unencrypted using the public key of the CA. He can then also be sure of the association between the first node and its public key. Other methods for producing signed certificates are known. Using such guarantees, connections can be opened in a scalable way since not everybody needs to know everybody else beforehand: it is only necessary to know the public key of the CA.

These mechanisms can theoretically be used by mobile wireless terminals such as mobile telephones. In practice, however, their deployment is difficult for a number of reasons.

Firstly, in order to participate in the authentication process of IKE, SSL, or TLS, a terminal needs a public-private key pair, as described above. The generation of this key pair requires a large amount of computational power, together with sophisticated software and preferably also a means for generating random numbers. Mobile wireless terminals frequently do not have sufficient resources to cope with these demands.

Furthermore, the terminal needs to obtain a certificate from a CA guaranteeing the association of the key pair, the user, and the CA. In order to do this, the user must provide identification information (which may for example require the user to attend the CA to present his or her passport), and must operate complex software on the terminal to correspond with the CA server over the Internet. In some cases, it is even necessary to copy and paste text between the terminal's user interface and an Internet server. These are complicated tasks on an ordinary mobile terminal, especially for inexperienced users. Again, the problem also arises that the terminal must have sufficient resources to run the complex software, and this is frequently not the case.

### SUMMARY OF THE INVENTION

It is an object of the present invention to overcome or at least mitigate the disadvantages noted in the preceding paragraphs. This and other objects are achieved at least in part by pre-storing keys and certificates created by a network operator on a SIM card for use by a mobile wireless terminal.

According to a first aspect of the present invention, there is provided a method of facilitating the authentication of an IP data transfer between a mobile wireless terminal and a network node via a radio access network (RAN), the method comprising the steps of:

generating a public-private key pair;

obtaining a certificate containing said public key, a unique identifier allocated to a subscriber, and a signature guaranteeing that the public key is associated with the unique identifier, the unique identifier being an identifier allocated to the terminal for the purpose of using the RAN;

storing the key pair and the certificate on a subscriber identity module (SM) card;

coupling the SIM card to the mobile wireless terminal so that processing means of the terminal can access the key pair and the certificate; and

sending the certificate to a network node, whereby the network node can use the certificate to authenticate the subscriber.

Embodiments of the present invention allow authentication data to be pre-calculated by a network operator or service provider, for example prior to the purchase of a terminal by a subscriber. The data is then stored on a SIM card which is inserted into a mobile.

This avoids the need for the data to be generated by the mobile terminal itself Preferably, the method comprises, at the network node, using the received certificate to identify the subscriber and determining the subscriber's access rights using an access permissions database.

It will be appreciated that the mobile wireless terminal has the capability to register with a mobile telecommunications network such as a GSM network or a UMTS network. The terminal may be a mobile telephone or communicator or a PDA, or a palmtop or laptop computer having mobile wireless facilities (this may be built in or could be in the form of a card inserted into a PCMCIA slot). Typically, the SIM card is inserted into a slot provided in the terminal (or card).

The unique identity allocated to a subscriber may be the telephone number of the subscriber, or may be an International Mobile Subscriber Identity (IMSI) code.

The certificate may be generated by a Certification Authority (CA) which “signs” the certificate to guarantee the association of the key pair and the unique identifier. The SIM card records the unique identity and the operator of the mobile network is trusted to store key pairs and certificates on SIM cards having the correct unique identifiers.

It will be appreciated that the IP data transfer between the mobile wireless terminal and the network node may involve networks in addition to the RAN, e.g. a core network of a mobile telecommunications network, the Internet, and/or an intranet.

According to a second aspect of the present invention, there is provided a method of authenticating IP data transfer between a mobile wireless terminal and a network node via a radio access network (RAN), the mobile terminal comprising a SIM card having stored thereon a public-private key pair and a certificate containing at least the public key, a unique identifier being an identifier allocated to the terminal for the purpose of using the RAN, and a signature guaranteeing that the public key is associated with the unique identifier, the method comprising:

sending the certificate from the mobile terminal to the node:

authenticating the terminal using said certificate; and

authorising the terminal to access a service of the node on the basis of said identifier.

The step of authorising the terminal may comprise looking up the unique identifier at the receiving node on a local database to find out if the mobile wireless terminal (or its user) has access rights.

The unique identifier may be, for example, an E.164 address or an international telephone number. These are both identifiers which are already present on a SIM card and are unique to each mobile terminal, and so can be relied upon.

The node may be, for example, a corporate security gateway or firewall.

Thus in order to authenticate a particular user, the organisation maintaining the network node must trust the network operator to ensure that the mapping of the certificate to the phone number is secure. The certificates mapped to the phone numbers (or other unique identifiers) act as a true global Public Key Infrastructure (PKI) and perform the authentication part of the connection to the network node.

According to a third aspect of the present invention there is provided a method of facilitating the authentication of IP data transfer between a mobile wireless terminal and a network node, the method comprising the steps of:

1) registering a subscriber to a mobile wireless telecommunications network;

2) generating a public-private key pair;

3) obtaining a certificate from a certification authority (CA) containing at least the public key, a unique identifier being an identifier allocated to the terminal for the purpose of using the telecommunications network, and a signature guaranteeing that the public key is associated with the unique identifier;

4) storing the key pair and the certificate on a subscriber identity module (SM card;

5) giving a mobile wireless terminal to the subscriber together with the SIM card; and

6) coupling the SIM card to the mobile wireless terminal whereby processing means of the terminal can access the certificate for sending to a remote node and the remote node can authenticate the subscriber on the basis of the certificate and can authorise access to services of the node on the basis of the unique identifier.

It will be appreciated that the steps 1) to 6) need not be performed in the order set out. For example, where the unique identifier is an IMSI code, step 1) may be performed after step 4). Step 6) may be performed either before or after step 5).

### BRIEF DESCRIPTION OF THE DRAWINGS

FIG. 1 illustrates schematically a Virtual Private Network (VPN) extending across the Internet and a Public Land Mobile Network (PLMN);

FIG. 2 is a flow diagram illustrating a method of initialising a mobile terminal for allowing authentication; and

FIG. 3 is a flow diagram showing the authentication of a mobile terminal to allow the transfer of IP data across the connection shown in FIG. 1.

### DETAILED DESCRIPTION OF THE PREFERRED EMBODIMENT

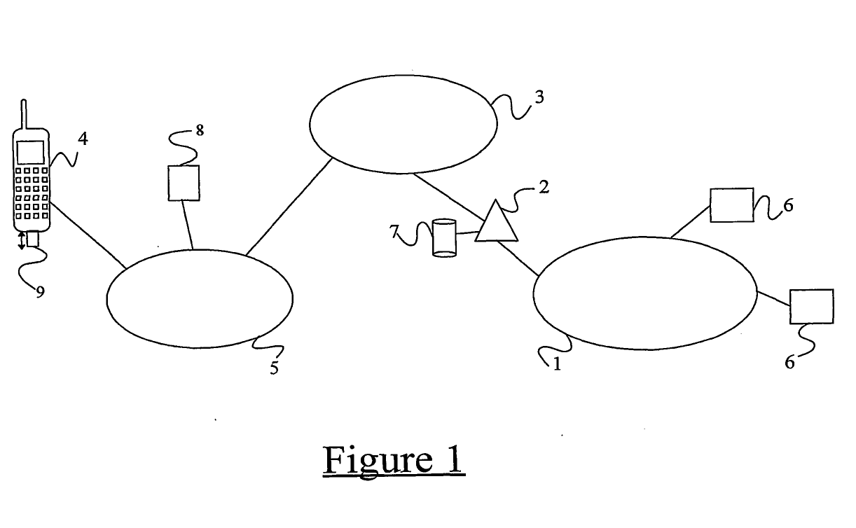

FIG. 1 illustrates a typical scenario in which a mobile wireless terminal and a corporate intranet together form a Virtual Private Network (VPN). A corporate intranet 1 is connected via a gateway 2 to the Internet 3. A remote mobile wireless terminal 4 may connect to the gateway via the Internet 3 and a Public Land Mobile Network (PLMN) 5 such as a GSM network. The mobile terminal 4 may be for example a mobile telephone or a PDA having wireless functionality. By using IPSec to control communication between the gateway 2 and the mobile terminal 4 (and hence between the mobile terminal 4 and local hosts 6), a Virtual Private Network (VPN) may be established. The mobile terminal must negotiate at least one pair of SAs (one for sending data and one for receiving data) with the gateway 2 prior to exchanging user generated traffic with the intranet 5.

Negotiation of SAs is carried out using Internet Key Exchange (IKE). Before IKE can start, each party must have a public-private key pair and a certificate from a CA guaranteeing the association of each party with its public key, as described above in the background to the invention.

The first stage of IKE involves a Diffie-Hellman exchange between the parties to generate a shared secret. Using this shared secret they encrypt their certificates (containing the public keys) and exchange these. Each party need only trust the CA to be able to be sure that the certificate guarantees the association between the other party and their public key.

The mechanism for obtaining public-private key pairs and certificates is complicated and computationally intensive, and beyond the capabilities of many mobile terminals.

This data is therefore created by the operator of the PLMN 5 rather than by the mobile terminals directly. The operator is already responsible for the allocation of ordinary telephone numbers, and provides SIM cards to users allowing them to use particular telephone numbers. It is therefore possible for the operator to add the public-private key pairs and certificates to the SIM cards issued to users. The certificates can use the allocated telephone number or the SIM cards unique IMSI as part of the identification information.

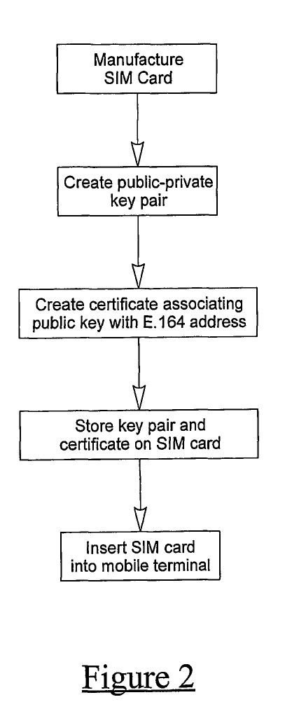

The sequence of events leading to the proper initialisation of a mobile terminal with the appropriate keys and certificates is shown in FIG. 2 and is as follows:

1. The SIM card 9 is manufactured and programmed by or on behalf of the operator.

2. The operator's chosen CA 8 is requested to create and provide a new public —private key pair. Alternatively, this can be performed inside the SIM card 9 so that the private key cannot “leak” out, whilst the public key remains visible. The operator may in some circumstances act as a CA.

3. The CA 8 constructs a new certificate for the key pair, and assigns the necessary names, preferably using the E.164 phone number as a part of the ASN.1 Distinguished Name in the X.509 certificate format. E.164 or +358 40 . . . format numbers are by definition globally unique.

4. The operator or his agent stores the keys and the certificates on the SIM card 9.

The SIM card 9 is thus equipped with a public-private key pair and a certificate guaranteeing the association of the public key with the E.164 address or telephone number. When the card is inserted into the appropriate slot of the mobile terminal 4 and the terminal is switched on and registered with the network 5, the terminal 4 is in a position to initiate IKE negotiation with the corporate intranet gateway 2.

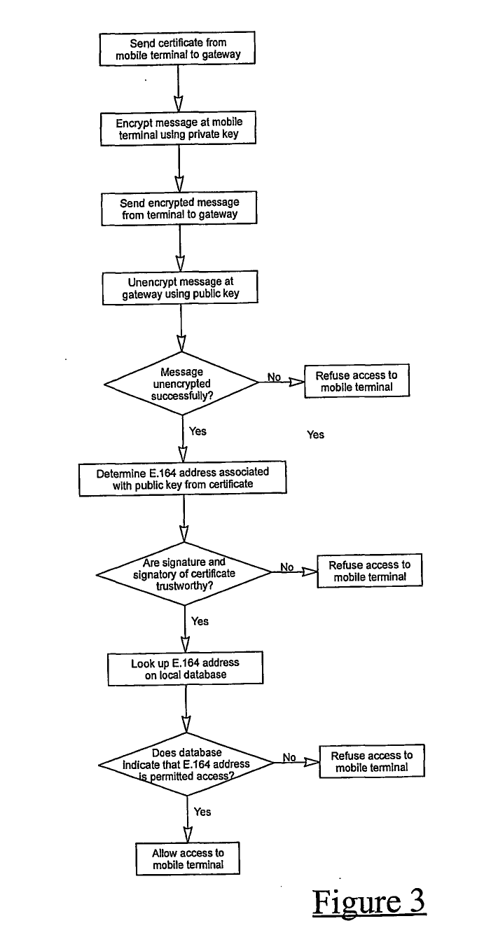

The gateway authenticates and authorises the user as follows (shown in FIG. 3):

1. The mobile terminal 4 opens IKE Phase 1 negotiation by sending the pre-stored certificate (containing its public key) to the gateway 4. Using the public key of the CA 8, the gateway 2 decrypts the signature contained in the certificate, and uses this to verify the association between the public key and identity (E.164 number) pair.

2. The mobile terminal 4 sends a message encrypted with its private key to the gateway 2.

3. The gateway 2 unencrypts the message using the public key of the terminal's public-private key pair. Assuming that the decryption process is successful, the gateway 2 can be sure of the identity of the mobile terminal 4.

4. The gateway 2 then proceeds to authorise the user by looking up the E.164 number or telephone number from a local database 7 (and “access permissions” database). This database may be constructed manually and contains a list of allowed users and their access rights. If listed, the mobile terminal 4 is allowed to connect.

5. Steps 1 to 3 are then repeated in reverse to authenticate the gateway 2 to the mobile terminal 4.

IKE Phase 2 negotiation then proceeds between the mobile terminal and the gateway to determine SAs for IPSec encryption.

If the host/gateway with which the mobile terminal wants to communicate is another terminal of the same operator (or the same group of operators), then the operator's root certificate can easily verify the identity of the other party. It only remains to describe the identities of the involved CA parties to the terminal's user and ask verification if he or she trusts this chain.

It will be appreciated by a person skilled in the art that variations may be made to the above described embodiment without departing from the scope of the invention.

1. A method of facilitating the authentication of an IP data transfer between a mobile wireless terminal and a network node via a radio access network (RAN), the method comprising the steps of:
generating a public-private key pair;
obtaining a certificate containing said public key, a unique identifier allocated to a subscriber, and a signature guaranteeing that the public key is associated with the unique identifier, the unique identifier being an identifier allocated to the terminal for the purpose of using the RAN;
storing the key pair and the certificate on a subscriber identity module (SIM) card;
coupling the SIM card to the mobile wireless terminal so that processing means of the terminal can access the key pair and the certificate; and
sending the certificate to a network node, whereby the network node can use the certificate to authenticate the subscriber.

2. A method according to claim 1 and comprising, at the network node, using the received certificate to identify the subscriber and determining the subscriber's access rights using an access permissions database.

3. A method according to claim 1 or 2, wherein the mobile wireless device has the capability to register with a GSM network or a UMTS network.

4. A method according to any one of the preceding claims, wherein the terminal is a mobile telephone or communicator or a PDA, or a palmtop or laptop computer having mobile wireless facilities.

5. A method according to any one of the preceding claims, where said unique identity allocated to a subscriber is the telephone number of the subscriber, or is an International Mobile Subscriber Identity (IMSI) code.

6. A method according to any one of the preceding claims, wherein the certificate is generated by a Certification Authority (CA) which signs the certificate to guarantee the association of the key pair and the unique identifier.

7. A method according to any one of the preceding claim, wherein the SIM card records the unique identity, and the operator of the mobile network is trusted to store key pairs and certificates on SIM cards having the correct unique identifiers.

8. A method of authenticating IP data transfer between a mobile wireless terminal and a network node via a radio access network (RAN), the mobile terminal comprising a SIM card having stored thereon a public-private key pair and a certificate containing at least the public key, a unique identifier being an identifier allocated to the terminal for the purpose of using the RAN, and a signature guaranteeing that the public key is associated with the unique identifier, the method comprising:
sending the certificate from the mobile terminal to the node:
authenticating the terminal using said certificate; and
authorising the terminal to access a service of the node on the basis of said identifier.

9. A method of facilitating the authentication of IP data transfer between a mobile wireless terminal and a network node, the method comprising the steps of:
1) registering a subscriber to a mobile wireless telecommunications network;
2) generating a public-private key pair;
3) obtaining a certificate from a certification authority (CA) containing at least the public key, a unique identifier being an identifier allocated to the terminal for the purpose of using the telecommunications network, and a signature guaranteeing that the public key is associated with the unique identifier;
4) storing the key pair and the certificate on a subscriber identity module (SIM) card;
5) giving a mobile wireless terminal to the subscriber together with the SIM card; and
7) coupling the SIM card to the mobile wireless terminal whereby processing means of the terminal can access the certificate for sending to a remote node and the remote node can authenticate the subscriber on the basis of the certificate and can authorise access to services of the node on the basis of the unique identifier.
